(19) United States
(12) Patent Application Publication
(10) Pub. No.: US 2013/0128277 A1
(43) Pub. Date: May 23, 2013

(54) ARRANGEMENT AND METHOD FOR INTERFEROMETRY

(71) Applicants: Holger Lubatschowski, Gehrden (DE); Ole Massow, Hannover (DE)

(72) Inventors: Holger Lubatschowski, Gehrden (DE); Ole Massow, Hannover (DE)

(21) Appl. No.: 13/696,392

(22) PCT Filed: May 5, 2011
(86) PCT No.: PCT/EP11/02246

§ 371 Date: Feb. 7, 2013

(30) Foreign Application Priority Data
May 7, 2010 (EP) 10004872.7

(51) Int. Cl. G01B 9/02

(52) U.S. Cl. CPC G01B 9/02091
USPC 356/479

(57) ABSTRACT

The invention relates to an arrangement for interferometry, including a light source for generating coherent radiation, a detector and a beam splitter for dividing the radiation generated by the light source. The radiation is divided into a sample arm in which a sample to be examined can be positioned and a reference arm. An optical reference element, which is partially transparent to the radiation, reflects a part of the radiation to the detector and behind which the sample to be examined can be positioned is disposed in the beam path of the sample arm.

The present invention relates to an arrangement for interferometry according to the preamble of claim 1 and to a corresponding method.

In medical engineering, in the examination of biological samples, and in material science, interferometric measuring methods have meanwhile established themselves. They permit to obtain information on the internal structure of the respective sample in a non-invasive manner. To this end, the radiation reflected from a certain depth within the sample is in general caused to interfere with a coherent proportion of radiation that has previously passed a reference arm of a certain length. In medical engineering, this measuring method is referred to as Optical Coherence Tomography, OCT. Basically, a distinction is made here between time domain OCT, TD-OCT, and frequency domain OCT, FD-OCT. In TD-OCT, the length of the reference arm is varied and the intensity of interference is continuously measured to measure the material properties of the sample in different depths. In FD-OCT, the interference of the individual spectral components of the signal is detected. This has the advantage that the length of the reference arm of the interferometer does no longer have to be varied.

The FD-OCT units use a spectrometer as detector. The so-called spectral interference, a modulation of the spectrum, is measured, wherein the modulation frequency is proportional to the path length difference from the reference mirror to an object in the sample arm. Since the frequencies of different objects can thus be superpositioned, the complete depth information can be detected in one single measurement with this method.

Conventional optical dual-beam (OCT) arrangements and corresponding methods for interferometry are known, for example, from A. Baumgartner, C. K. Hitzenberger, E. Ergun, M. Stur, H. Sattmann, W. Drexler, A. F. Fercher, “Resolution-improved dual-beam and standard optical coherence tomography: A comparison”, Graefe's Arch. Clin. Exp. Ophthalmology 238, 385-392 (2000), from W. Drexler, C. K. Hitzenberger, H. Sattmann, A. F. Fercher, “Measurement of the thickness of fundus layers by partial coherence tomography”, Opt. Eng. 34, 701-710 (1995), from W. Drexler, O. Findl, R. Menapace, A. Kruger, A. Wedrich, G. Rainer, A. Baumgartner, C. K. Hitzenberger, A. F. Fercher, “Dual beam optical coherence tomography: signal identification for ophthalmologic diagnosis”, Journal of Biomedical Optics 3(1), 55-65 (1998), from A. F. Fercher, W. Drexler, C. K. Hitzenberger, T. Lasser, “Optical coherence tomography—Principles and applications”, Rep. Prog. Phys. 66, 239-303 (2003), or from C. K. Hitzenberger, “Optical Measurement of the axial eye length by laser Doppler interferometry”, Investigative Ophthalmology & Visual Science 32(3), 616-624 (1991).

In the medical field, OCT is, to a very low extent, used for cancer diagnostics and skin examination, but to a greater extent in the field of ophthalmology. Compared to other tissues, the eye has the advantage that its components for the employed radiation are hardly scattering, so that the penetration depth in OCT is increased. Commercially available OCT units have, for example, an imaging depth of about 3 mm.

In the field of ophthalmology, information on the condition and the internal structure of the eye can be obtained by means of OCT. This information can be consulted as a basis for the control of a subsequent treatment of the eye.

Such treatments are by now often carried out with lasers. For example, DE 10 2008 005 053 A1 describes a method of correcting sight defects at the natural eye lens. By a laser treatment of the eye lens, presbyopia can also be treated. The human eye becomes presbyopic because the lens of the human eye looses elasticity as it is getting older, leading to a hardening of the lens and thus to a loss of Accommodation Samplitude. With increasing age, the image can be sharply focused on the retina only across an ever decreasing distance range. Treatment of presbyopia is enabled by processing the eye lens with a laser to increase its flexibility again.

In a later stadium, the human eye lens usually hardens further and is getting turbid. This disease is referred to as cataract (eye cataract). To treat this disease, the hardened lens is crushed with an ultrasound cannula and removed from the eye. A plastic lens is implanted to replace it.

Both the treatment of presbyopia and the crushing of the hardened lens in a cataract disease can be done by ultra-short pulse lasers. The foci of the individual laser pulses must here be placed purposefully at predetermined points within the eye lens, so that the desired treatment pattern results.

However, the dimensions of the components of the eye vary from patient to patient. Only when the spatial relation of these components and their extensions are precisely known, a laser treatment of the eye can be carried out precisely.

A disadvantage of the conventional OCT units is in this connection the already mentioned restriction of their imaging depth to about 3 mm. The area of the eye relevant for a laser treatment of an eye comprises the cornea, the area between the cornea and the lens front face, and the eye lens. These components of the eye have the following dimensions along the optic axis: The cornea has a thickness of about 500 μm, the distance between the cornea's rear side and the lens front face is about 4 mm, and the eye lens itself has a thickness of 4 to 6 mm. Consequently, with commercially available OCT systems, neither the eye lens altogether, nor the complete anterior chamber between the cornea's rear side and the lens front face can be represented. Vice-versa, the individual components of the eye are essentially thinner than the imaging depth of the OCT or highly transparent to the employed radiation. Consequently, the representation area of a few millimeters is often not completely utilized due to the size of the sample.

It is the object of the present invention to provide, with means that are structurally as simple as possible, an arrangement and a method for interferometry which permit a clearly improved representation of the sample to be examined.

This object is achieved by an arrangement having the features of claim 1 and by a method having the features of claim 9, respectively. Advantageous further developments of the invention are stated in the sub-claims.

The (optical or measurement) arrangement according to the invention for interferometry is characterized in that an optical reference element, which is partially transparent to the radiation, reflects a part of the radiation to the detector and behind which the sample to be examined can be positioned, is disposed in the beam path of the sample arm. If the sample is not further away from the reflecting surface of the reference element than the coherence length of the employed radiation, an interferometric measurement can be carried out with the proportions of radiation reflected from the sample and at the reference element as with a common path interferometer. Additionally, further interferometric measurement can be done with the proportion of radiation reflected from the sample and passing through the reference arm (i.e. as in a Michelson interferometer). So, two interferometric paths result in a structurally simple manner. The advantage of the invention consists in the fact that the two interferometric measurements cannot only be effected simultaneously but can detect different depths in the sample to be examined. The interferometric measurement with the proportion of radiation reflected at the reference element will detect structures near the surface of the sample (for example to a depth of 3 mm), while the interferometric measurement with the proportion of radiation from the reference arm will detect deeper structures in the sample (for example in a depth of 3 to 6 mm). Moreover, the invention offers the following advantages, among others:
The arrangement for interferometry according to the invention has a comparatively simple design (and is consequently hardly susceptible to failure) because it can do with one single beam division—in contrast, for example, to dual- or multi-beam OCT.
By the interferometry arrangement according to the invention, which avoids several reference arms or utilizes the sample arm as second reference arm, respectively, more light gets onto the sample, and the signal-to-noise ratio is improved.
By the easily measurable distance (which can even be reduced to zero) between the reflecting surface of the reference element and the sample, the depth information of the structures determined in the sample is intrinsic and exactly defined.

Preferably, the surface of the reference element facing the sample is plane. By a partially reflecting coating and/or by a step in the index of refraction at this surface, one can obtain a reflection of a part of the coherent radiation from this surface onto the detector. It is here advantageous for the partially reflecting surface of the reference element to be oriented in such a way that a maximum amount of reflected light gets to the detector. If this surface is plane, this moreover facilitates the determination of the distance between the reference surface of the element and the sample.

It is particularly advantageous if the sample can be positioned in direct contact with the reference element. In this manner, the step in the index of refraction between the material of the reference element (for example glass) and the sample can be utilized for reflecting the coherent radiation. This position is also advantageous because by this, a particularly deep region of the sample is still within the coherence length of optical radiation, measured from the partially reflecting surface of the reference element. Moreover, in elastic or gel-like samples (for example soft tissue, such as eyes, but also elastomer plastics), there is the advantage that the sample is brought into a defined shape by contact with the reference element.

Preferably, the reference element is wedge-shaped. Different to the use of a plane-parallel plate, further interferometric referencing by the light reflected again onto the sample from the upper side of the plate is avoided by this.

In an advantageous variant of the invention, the optical path length of the reference arm and/or the sample arm—in each case starting from the beam splitter—can be varied. This permits to detect structures in different depths in the sample by interferometry. Moreover, the measured regions in different depths can be partially superimposed, so that the spatial relation of the structures detected in a measured region to the structures detected in the other measured region can be identified. With a conventional common path interferometer, an independent change of the optical path length of the reference arm and the sample arm is not possible.

By the combination of the two interferometer types according to the invention, the respective reference surfaces can be shifted separately with respect to the sample. Here, it is particularly suitable for the optical path lengths of the reference arm and/or the sample arm to be adjustable such that these optical path lengths (each starting from the beam splitter) are completely matched. If these path lengths correspond to each other, the two interferometric paths of the arrangement according to the invention detect structures in the same depth within the sample. By this, the two interferometric paths can be mutually calibrated.

A focusing element is preferably provided in the sample arm. It takes care of restricting the examination of the sample to a certain region and of increasing the available light intensity within this region.

It is particularly advantageous if the focusing element comprises such a refractive power for the radiation that the optical path length of the sample arm from the beam splitter to the focus of the focusing element is longer than the optical path length of the reference arm at most by the Rayleigh length of the radiation. The Rayleigh length is the distance along the optical axis within which the cross-sectional area of a laser beam doubles (starting from the beam waist). This Rayleigh length z_{R} can be calculated by the formula Z_{R}=π·w₀²/λ, wherein w₀ is the beam radius in the focus and λ is the wavelength of the employed light. If the regions of the sample that can be represented by the two interferometric paths of the arrangement according to the invention are together located within the Rayleigh length, an optimal signal-to-noise ratio and an optimal lateral resolution result (as otherwise the light intensity between the one examined region and the other examined region would decrease too much).

The invention not only relates to an interferometric arrangement but also to a method for interferometry which can be carried out with the above described arrangement. In this method, the interference of a first beam proportion passing through the reference arm is measured with a second beam proportion getting from the sample onto the detector. Additionally, the interference of a third part of the beam getting from a reference element arranged in front of the sample in the sample arm, which is partially transparent to the radiation onto the detector is measured with a fourth part of the beam getting from the sample onto the detector. As was already illustrated above, in a structurally simple manner and optionally even simultaneously, information on structures from differently deep regions of the sample can thus be obtained. Compared to conventional interferometry measurement, for example by a conventional OCT unit, the detected depth range can be doubled, for example, from 3 mm to 6 mm, while the resolution of a conventional system with a depth range of only 3 mm is simultaneously maintained.

As was already illustrated above, further advantages result if the sample is placed in direct contact with the reference element during measurement, if the regions of the sample detected by the two interferometric paths of the measurement arrangement are not further apart from each other than the Rayleigh length of the radiation defined by the focusing element, and/or if the reference arm and the sample arm are adjusted for calibration such that their optical path lengths are identical.

By the method according to the invention, not only in-vivo samples, but also ex-vivo samples can be examined, for example extracted or artificial samples of biological or organic material, plants or suited plastics or glasses.

Below, an advantageous embodiment of the invention will be illustrated more in detail with reference to the drawings. The drawings show in detail:

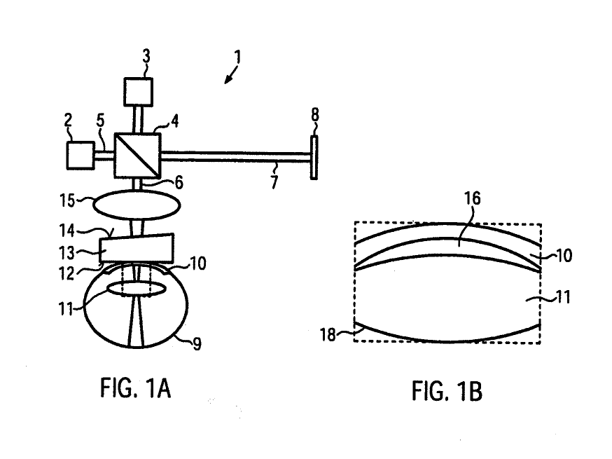

FIG. 1A a schematic design of the optical arrangement according to the invention;

FIG. 1B a schematic view of the measured data obtained with the arrangement according to the invention;

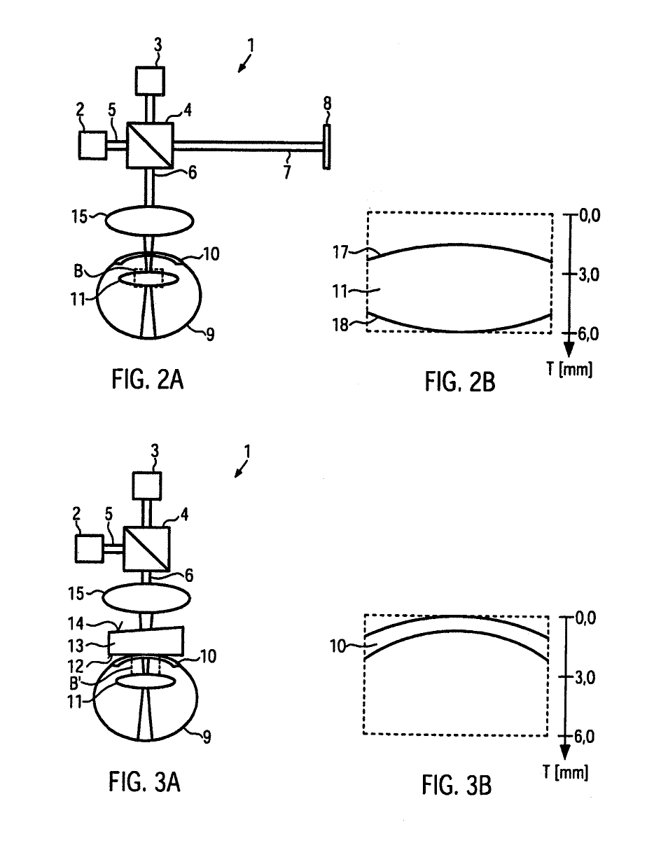

FIG. 2A a first interferometric path of the arrangement shown in FIG. 1A,

FIG. 2B a representation of the measured data obtained in the first interferometric path;

FIG. 3A a second interferometric path of the arrangement shown in FIG. 1A, and

FIG. 3B a representation of the measured data obtained in the second interferometric path.

FIG. 1A shows, in a schematic representation, a (measurement) arrangement 1 according to the invention. The arrangement 1 has a light source 2 for generating coherent radiation, i.e. a laser. The laser can be a pulsed laser, for example an ultra-short pulse laser, that generates a broad spectrum appropriate for FD-OCT.

A detector 3 is provided for obtaining interferometric measurement data. The detector 3 can be a CCD camera. The detector 3 is connected with a suited evaluation unit and a display device (not represented).

A beam splitter 4 divides the coherent radiation 5 generated by the light source 2 into a sample arm 6 and a reference arm 7. The beam splitter 4 is the only beam splitter within the arrangement 1 according to the invention. In alternative embodiments, several beam splitters 4 can also be used and coupled by optical fibers, so that one can separate different set-ups from each other.

At the end of the reference arm 7, there is a reflector 8. It is oriented such that the light passing through the reference arm 7 and reflected by the latter is deflected to the detector 3 via the beam splitter 4.

The sample 9 to be examined, in the represented case a human eye, is disposed at the end of the sample arm 6. This eye 9 has a cornea 10 and an eye lens 11.

A region of the front side of the cornea 10 is in direct contact with a plane rear face 12 of a reference element 13. By the contact, preferably supported by pressing the reference element 13 against the sample 9, the reference element 13 has an applaning effect on the part of the sample 9 in contact with it. The reference element 13 is designed as optical wedge as its front side 14 is not in parallel to its rear face 12.

The rear face 12 of the reference element 13 is partially reflecting for the radiation 5 passing through the sample arm 6 due to a corresponding coating and/or a step in the index of refraction between the reference element 13 and the material of the sample 9. It thus forms the reference surface of the reference element. The reference element 13 can consist, for example, of glass.

Between the beam splitter 4 and the reference element 13, a lens is arranged as a focusing element 15. The lens 15 is selected such that it focuses the radiation in the sample arm 6 to a comparably weak degree. By this, the Rayleigh length of the radiation is relatively long, and via the two interferometric paths of the arrangement 1, information from clearly spaced apart depths (i.e. several millimeters) of the sample 9 can be obtained. If the central wavelength of the radiation 5 generated by the light source 2 is, for example, approximately 700 nm, the beam radius w₀ generated by the lens 15 could be 30 μm to obtain a Rayleigh length of about 4 mm. Centers of the two regions detected by the respective interferometric paths of the arrangement 1 can be apart from each other at most by this Rayleigh length z_{R}. At maximum, the two detected regions could even be spaced apart by up to twice the Rayleigh length to be able to still carry out the two measurements with a good signal-to-noise ratio and a good lateral resolution.

FIG. 1B shows the information on the structures in the sample 9 obtained with the arrangement 1, so in the present case information on the topography of the cornea 10 and the eye lens 11 and on the anterior chamber 16 of the eye 9 lying between these two structures. In which manner these data are obtained will be illustrated below with reference to FIGS. 2 and 3.

FIG. 2A schematically shows a first interferometric path of the arrangement 1 according to the invention. In this first interferometric path, the reflection by the reference element 13 is of no importance. Therefore, the reference element 13 is not shown in FIG. 2A

The first interferometric path represented in FIG. 2A corresponds to a Michelson interferometer. A first part of the beam of the radiation 5 generated by the light source 2 passes through the reference arm 7 and gets from there to the detector 3 via the beam splitter 4. In the detector 3, this first part of the beam interferes with a second part of the beam getting from the sample 9 onto the detector 3. This interferometric measurement can be done in the form of TD-OCT (where the depth of the structures detected in the sample 9 is determined by the optical path length of the reference arm 7), but is preferably done by means of FD-OCT where different spectral proportions are caused to interfere to simultaneously obtain information on different depths in the sample 9. The focusing element 15 is here selected and positioned in such a way that sufficient light intensity is available in the depth of the sample 9 to be examined.

The region B of the sample 9, from which information is obtained by interferometric measurement, is represented in FIG. 2A by a box drawn in a dashed line. The corresponding detail which will also be shown on a display device of the detector 3 is shown enlarged in FIG. 2B. One can see here that by the interferometric measurement in the first path, information on the topography of the eye lens 11 are obtained, namely about the position and curvature of its front face 17 and its rear face 18. These surfaces are located at a depth T of, for example, 2 to 5 mm below the surface of the eye 9.

FIG. 3A shows, in a schematic representation, a second interferometric path of the arrangement 1. Since the reference arm 7 in this path is not important, it is not shown in FIG. 3A. The second interferometric path shown in FIG. 3A corresponds to a common path interferometer. Here, a third portion of the radiation 5 in the sample arm 6 is reflected onto the detector 3 by the partially reflecting rear face 12 of the reference element 13. There, this third part of the beam interferes with a fourth part of the beam that is getting from the sample onto the detector, insofar as this fourth part of the beam is within the coherence length of the radiation (starting from the rear face 12 of the reference element 13). The region B′ within the sample 9, from which information are obtained, is thus close below the surface of the sample 9. This region B′ is represented in FIG. 3A with a dashed box and shown in FIG. 3B in an enlargement. In the present embodiment, information on the structure and the curvature of the cornea 10 of the eye 9 are obtained by the second interferometric path. One can clearly see in FIG. 3B that the central section of the cornea 10 is applaned by its abutment against the reference element 13. By the second interferometric path, information in a depth of 0 to 3 mm can be obtained from the sample 9.

The measurement arrangement 1 according to the invention shown in FIG. 1A is a combination or superposition of the two interferometric paths shown in FIGS. 2A and 3A. Here, several optical components are used together, for example the beam splitter 4 and the focusing element 15. According to the inventive method, the measurements of the two paths of the interferometric arrangement are carried out simultaneously or one after another. By the measured regions of the two interferometric paths being located in different depths of the sample 9, information on the internal structure of the sample can be obtained over a wide depth range of the sample 9. The measuring results of the measurements in the two interferometric paths can also be combined, as is represented in FIG. 1B. FIG. 1B shows the structures both of the eye lens 11 and of the cornea 10 of the eye 9 under examination. By the possibility of superposing congruent structures from the two marginal regions of the respective measured regions B, B′ (for example by imaging software that detects structures) the spatial relations of the structures detected in the two measured regions B, B′ can be identified. Additionally or as an alternative to such a superposition of congruent structural image features, it is possible to match the two interferometric paths. To this end, the optical path length of the reference arm 7 is adjusted such that it corresponds as exactly as possible to the optical path length of the sample arm 6, i.e. to the distance between the beam splitter 4 and the partially reflecting surface 12 of the reference element 13.

Starting from the represented embodiment, the arrangement 1 according to the invention and the method according to the invention can be modified in many ways. For example, it is possible to operate the arrangement not as FD-OCT, but as TD-OCT.

1-12. (canceled)

13. Arrangement for interferometry, comprising:
a light source for generating coherent radiation,
a detector,
a beam splitter for dividing the radiation generated by the light source into a sample arm in which a sample to be examined can be positioned, and a reference arm,
wherein an optical reference element, which is partially transparent to the radiation, which reflects a part of the radiation to the detector and behind which the sample to be examined can be positioned, is disposed in the beam path of the sample arm,
and in that in the sample arm, a focusing element is provided, the focusing element having such a refractive power for the radiation that the optical path length of the sample arm from the beam splitter to the focus of the focusing element is longer than the optical path length of the reference arm maximally by the Rayleigh length of the radiation,
and in that a reflector in the reference arm and/or the optical reference element in the sample arm can be offset independently of each other.

14. Arrangement according to claim 13, wherein the reference element comprises a plane surface facing the sample.

15. Arrangement according to claim 13, wherein the sample can be positioned in direct contact with the reference element.

16. Arrangement according to claim 13, wherein the reference element is wedge-shaped.

17. Arrangement according to claim 13, wherein the optical path length of the reference arm and/or the sample arm—in each case starting from the beam splitter—is variable.

18. Arrangement according to claim 13, wherein the optical path length of the reference arm and/or the sample arm can be adjusted such that the optical path lengths—in each case starting from the beam splitter—are identical.

19. Method for interferometry, wherein coherent radiation is divided into a sample arm and a reference arm, wherein in the sample arm, a sample to be examined is positioned, and wherein the following is measured by using a detector:
the interference of a first part of the beam passing through the reference arm with a second part of the beam getting from the sample onto the detector, and
the interference of a third part of the beam getting from a reference element, which is partially transparent to the radiation and which is disposed in the sample arm in front of the sample, onto the detector with a fourth part of the beam getting from the sample onto the detector,
wherein furthermore the radiation in the sample arm is focused by using a focusing element, and the focusing element has such a refractive power for the radiation that the optical path length of the sample arm from the beam splitter to the focus of the focusing element is longer than the optical path length of the reference arm maximally by the Rayleigh length of the radiation.

20. Method according to claim 19, wherein the sample is positioned in direct contact with the reference element in the measurement.

21. Method according to claim 19, wherein the reference arm and the sample arm are adjusted for calibration such that their optical path lengths are identical.
